(19) United States
(12) Patent Application Publication
(10) Pub. No.: US 2002/0023915 A1
(43) Pub. Date: Feb. 28, 2002

(54) Glass or glass ceramic plate with a safe edge and method for the manufacture thereof

(76) Inventor: Martin Taplan, Rheinbollen (DE)

Correspondence Address: FULBRIGHT & JAWORSKI, LLP, 666 FIFTH AVE, NEW YORK, NY, 10103-3198, US

(21) Appl. No.: 09/935,702

(22) Filed: Aug. 21, 2001

(30) Foreign Application Priority Data
Aug. 22, 2000 (DE) 100 41 006.5

(51) Int. Cl. H05B 3/68

(52) U.S. Cl. 219/452.11; 219/452.12; 219/468.2

(57) ABSTRACT

In a glass or glass ceramic plate for a kitchen appliance the safe edge is to be improved. This safe edge is formed by a rounded rim (5) having a thickness greater than that of the plate (1), which merges integrally and seamlessly with the plate (1).

The invention relates to a glass or glass ceramic plate for a kitchen appliance, especially a cook top or bake surface which has a safe edge, and to a method for its manufacture.

In the state of the art, glass and glass ceramics are used in kitchen appliances. they are characterized by having a nonporous, hygienic and easily cleanable surface and lastingly withstand the temperature fluctuations that occur. Glass ceramic cook tops are widely used on account of their flat, easy-to-clean surface and their permeability to radiation. In bake ovens glass plates are used as baking dishes or as grease pans. In refrigerators glass plates are used as shelves.

The known glass and glass ceramic plates require safety edging in order to protect the sharp edges and/or to enable the plate to be held in a tension-free manner in the kitchen appliance and/or to reduce the risk of breakage. In the state of the art the glass or glass ceramic plates are therefore provided with a frame. Commonly used frames consist of enameled steel shapes, stainless steel shapes, aluminum shapes or plastic shapes which are glued or clamped on the plate. For the production of such frames special tools are necessary and fastening the frame to the plate involves considerable assembly work. This increases the cost of edge-protected glass or glass ceramic plates.

In ordinary frames a seam necessarily exists between the frame and the plate, with the result that between the safe edge and the plate critical areas exist which ultimately cannot be perfectly cleaned. This is especially because it must be expected that during cooking or baking or when foods are stored, liquids will enter the seams and dry therein, which may also entail a bad smell that is not easy to get rid of.

The known frames are hardly suitable in practice for limiting the amount of liquid that gets onto the plate. The liquid will then get into the seam between plate and frame and be difficult to remove.

In GB 2,323,922 A a glass ceramic insert manufactured as a molded part for a single burner is described. The glass ceramic insert has a thinned, outwardly protruding marginal area. No strengthened edge protection is thereby produced.

DE 79 14 111 U1 discloses a book unit with at least one electrical cook plate which is inserted into an opening in a plate unit of vitreous or ceramic material. The manufacture of such a plate unit is complicated. No protection of the exposed edge of the plate unit is provided.

In DE 298 13 810 U1 a cook top with a glass ceramic cook surface is described. The glass ceramic cook surface is set into a supporting frame which offers it a certain edge protection.

EP 0 710 800 A1 discloses a planar glass ceramic cook surface which is rounded at its outer edge.

In U.S. Pat. No. 5,931,152 A a shaped glass ceramic plate for a gas stove is described. The shaping is achieved by a vacuum drawing method. No special edge production is provided.

The problem addressed by the invention is to propose a glass or glass ceramic plate of the kind referred to in the beginning, in which the safe edge is improved and simplified, especially in regard to lasting cleanliness. Another problem is to provide a method for the manufacture of the plate.

According to the invention the above problem regarding the plate is solved by the features of claim 1 and, with regard to the method of its manufacture, by the features of claim 13.

It is thus brought about that there is no seam between the safe edge and the plate intended for bearing cooking or baking utensils or foods in containers. The cross-sectional profiled portion formed on the plate itself forms the safe edge, which on the one hand can eliminate the sharp edge from the outer margin of the plate, and on the other hand can also serve for the mounting or fastening of the plate, without thereby being exposed to such stresses as an additional frame would create. The ordinary frames of the state of the art are unnecessary. This reduces the cost of protecting the edges of a glass or glass ceramic plate.

Since there is no seam between the profiled portion and the plate, thorough cleaning is always possible. Since it consists of the same material as the plates, the safe edge formed by the profiled portion is just as non-porous as the plates.

Preferably, the profiled portion projects above the top and/or below the bottom of the plate. thus forming a catchment on the plate in which liquid escaping from cooking or baking utensils can collect. The bottom recess can serve to cover a sealing strip provided on the bottom surface or to assure a defined distance between the glass plate and anything under it. This can be advantageous if the plate serves as a slide-in shelf for a bake oven (cf. FIG. 7) and to prevent scorching something (a kitchen tablecloth, for example) on which it is placed. In this case the glass surface will not come in contact with the tablecloth.

Preferably the outside edge of the guard is rounded. Such rounding avoids sharp corners, reduces sensitivity to impact and improves the stability of the plate.

Additional advantageous features of the invention will be found in the following description of embodiments. In the drawing:

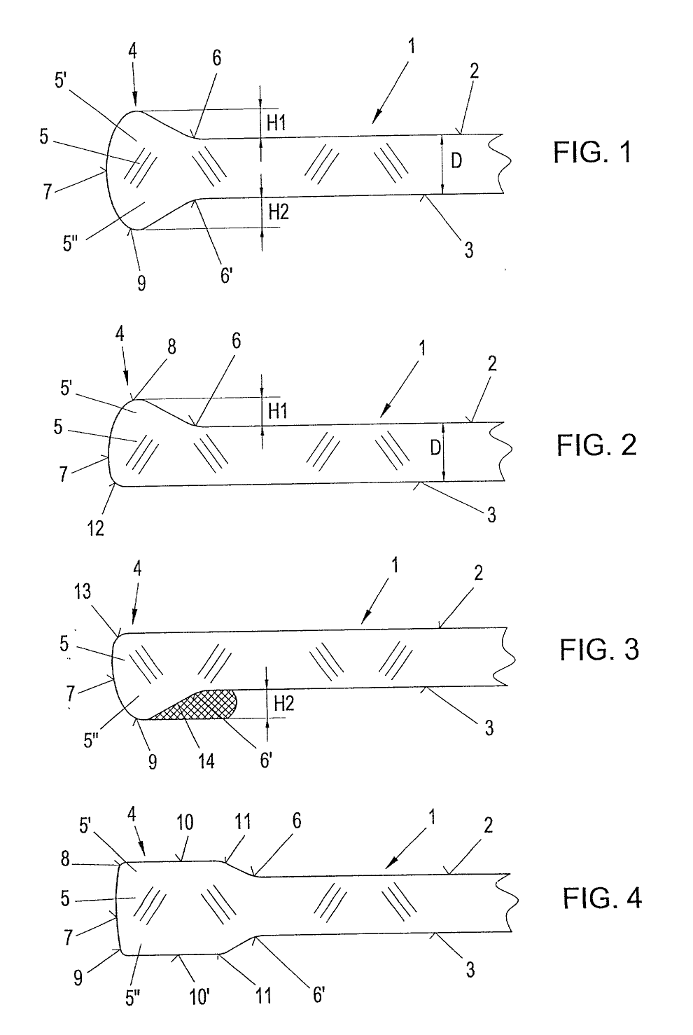

FIG. 1 is a fragmentary sectional view of a glass ceramic plate with a marginal profiled portion above the top and below the bottom thereof,

FIG. 2 an alternative to FIG. 1 with a marginal profiled portion above the top thereof,

FIG. 3 an alternative to FIG. 1 with a marginal profiled portion below the bottom thereof,

FIG. 4 an alternative to FIG. 1 with flattened areas,

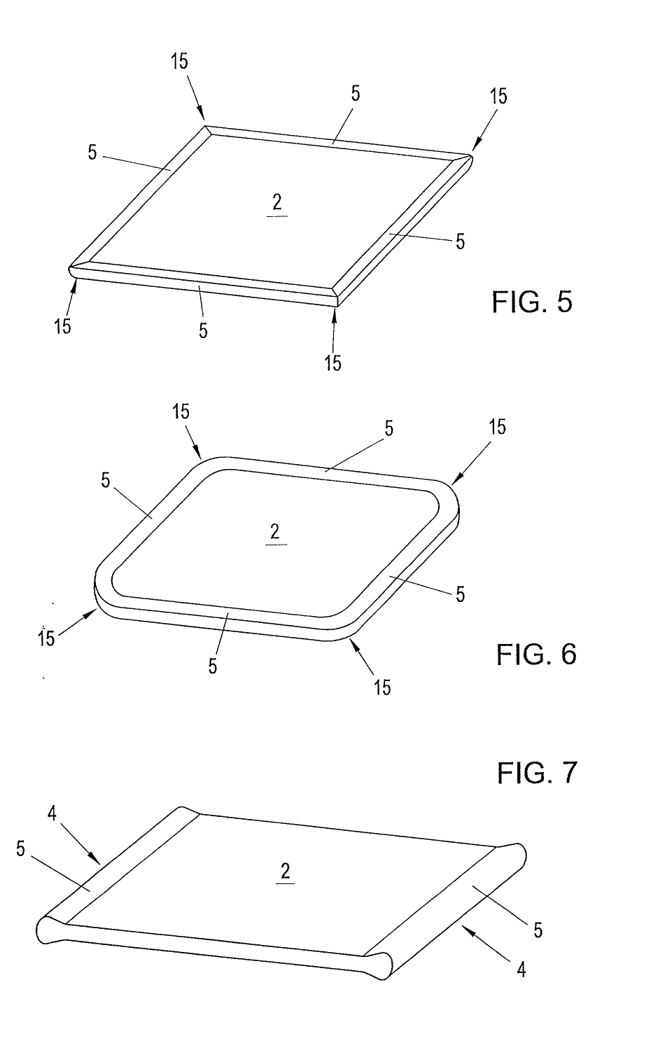

FIG. 5 a perspective view of a glass ceramic plate with a thickened profiled portion around all four margins,

FIG. 6 an alternative to FIG. 5, wherein the plate is rounded at the corners,

FIG. 7 a glass plate with a thickened profiled portion on two opposite margins.

A glass plate 1 has a planar upper side 2, as a cook surface for example, and a plane-parallel bottom 3 of a conventional thickness D. It can also be imagined, however, that the upper surface departs in some areas from the planar form in order to accommodate working elements or form functional areas. This applies especially to switch areas or gas burner lead-throughs or the like. At the margin 4 of the glass plate the safe edge is in the form of a cross-sectional profiled portion 5 thicker than the thickness D of the plate 1, which merges integrally and seamlessly with the top side 2 and bottom side 3. In the transition zone or zones a hollow curvature 6, 6′, is formed. The profiled portion 5 is rounded at its end face 7 such that no sharp edges are on it.

In an upper area 5′ the profiled portion 6, in the embodiment in FIG. 1, is higher than the top surface 2 by the difference H1, and in a lower area 5″ it is lower than the bottom side 3 by the difference H2. The differences H1 and H2 are approximately 1 to 5 mm. They are preferably less than the thickness D of the plate 1.

In zone 5′ of the profiled portion there is a convex curve 8 which merges with the curvature 6. In zone 5″ of the profiled portion there is a concave round 9 which merges with the curvature 6′.

Between round 8 and hollow round 6 and/or round 9 and hollow round 6′ flattened areas 10, 10′ (cf. FIG. 4) can be formed, which are parallel or approximately parallel with the upper side 2 and bottom side 3, respectively. The flattened areas 10, 10′ in turn merge via rounds 11 with the hollow rounds 6, 6′. The flattened areas 10 can improve the possibilities for mounding or fastening the plate 1 to or in a baking or roasting oven.

In the embodiment shown in FIG. 2 the area 5′ of the profiled portion projects by the amount H1 above the top side 2 of plate 1. The profiled portion 5 merges level with the bottom side 3 at a rounded edge 12. Vice versa, in the embodiment in FIG. 3 the profiled portion zone 5″ projects below the bottom side 3; the profiled portion 5 merges level with the top side 2. In the embodiments according to FIGS. 2 and 3 the flattened areas 10 and 10′ described above can be provided, respectively.

The profiled portion 5 in the embodiments according to FIGS. 5 and 6 is provided all around the four margins of the glass or glass ceramic plate 1. The height (difference H1) of the continuous circumferential profiled portion 5 at its upper level 5′ (cf. FIG. 1, FIG. 2, FIG. 4) creates on the top side 2, which forms a cooking or baking surface, a recess to contain any liquid issuing from cooking or baking utensils. In common cook surfaces made of glass ceramic plates, the cooking surface, i.e., the top side 2, has an area of about 50 cm×60 cm, or 3000 cm². In the case of a difference H1 of about 3 mm, the capacity is about 900 cm³, i.e., nearly 1 liter. So any amount of liquid up to about 1 liter leaking onto the cook surface will collect without running over the margin 4 or profiled portion 4 and without penetrating into seams or corners. Any leakage can easily be absorbed with a sponge or a cloth, and a thorough, hygienic cleaning is not difficult.

As a result of the difference in level between the lower profiled portion zone 5″ (cf. FIG. 1, FIG. 3 and FIG. 4) and the bottom side 3, the plate 1 can be shelved with its bottom side 3 raised. At the round 6′ a circumferential, elastic gasket 14 (shown in broken lines in FIG. 3) can be installed which, especially in a kitchen oven with a glass ceramic plate, will prevent the penetration of liquid into the space below the bottom 3, in which electrical radiant heaters or gas-fueled radiant heaters are usually disposed. At the same time the profiled portion zone 5″ covers the gasket 14 so that it is hardly visible if at all from the front end 7.

Mounting the gasket 14 in the area of the round 6′ helps to retain it so that it will not slip out when it is necessarily compressed when it is installed. The plate 1 can be affixed, by cementing for example, at its profiled portion zone 5″ or at the bottom side 3, to a substructure of the oven.

In the embodiment in FIG. 6, in contrast to FIG. 5, the comers 15 of the glass plate 1 are rounded. The profiled portions 5 can here again easily be made continuous all around, which is hardly possible, or possible only at great expense, in the state of the art with a frame made of separate components.

In the embodiment in FIG. 7, in contrast to the embodiments in FIGS. 5 and 6, thickened profiled portions 5 are provided only at two opposite, parallel margins 4 of the glass plate 1. The profiled portions 5 can be configured as described in connection with FIGS. 1 to 4.

The glass plate 1 in FIG. 7 can be used as a shelf which can be inserted into a bake oven or a refrigerator, in which case the profiled portions 5 are intended to lie upon guide means.

Since its profiled portion 5′ serves as framing or safe edgeing function, the glass or glass ceramic plate described has especially the following advantages:

a) No frame of separate components needs to be provided and cemented or clipped to the plate 1.

b) There are no seams between the profiled portion 5 and the plate as such, in which hard-to-remove dirt or remnants of liquids can collect.

c) The connection between the plate 1 and the profiled portion 5 is permanent and not subject to the aging of adhesives.

d) Direct fastening of the plate 1 at the profiled portion 5 to a supporting structure of a cook oven is possible.

e) A concealed gasket and fastening of the plate 1 to a supporting structure is possible.

f) The profiled portion 5 increases the stability of the plate 1 and improves its impact strength.

g) Stresses due to temperature changes do not occur between the glass plate 1 and its margin 4 because the glass plate 1 and the profiled portion 5 consist of the same material.

h) A drip-catching capacity is easily arranged for liquid falling on the upper side 2 of the glass plate, combined with ease in cleaning.

i) A space can be arranged between a supporting surface and the glass plate 1.

The profiled portion 5 is made on the plate 1 approximately as follows:

A glass plate 1 rolled flat and appropriately shaped is heated in the green state and to prevent thermal tensions it is additionally heated in its marginal area and upset or shaped in the marginal area by means of a shaping tool so as to form the profiled portion 5. Then the glass plate is brought out of its green state in an additional process step, especially by heat treatment and/or ceramization, to its finished state.

1. Glass or glass ceramic plate for a kitchen appliance, especially a cooking or baking surface, wherein the plate has a safe edge, characterized in that the safe edge is formed by a cross-sectional profiled portion (5) thicker than the thickness (D) of the plate (1), which merges integrally and seamlessly with the plate (1) and is upset or shaped on the rolled plate (1).

2. Glass or glass ceramic plate according to claim 1, characterized in that the profiled portion (5) projects above the upper side (2) and/or below the bottom side (3) of the plate (1).

3. Glass or glass ceramic plate according to either of the foregoing claims, characterized in that the upper side (2) and/or the lower side (3) of the plate is flat within the profiled portion (5).

4. Glass or glass ceramic plate according to claim 1 or 2, characterized in that the upper side (2) differs in partial areas from a planar shape.

5. Glass or glass ceramic plate according to any one of the foregoing claims, characterized in that the profiled portion (5) is a holding zone for the mounting of the plate (1).

6. Glass or glass ceramic plate according to any one of the foregoing claims, characterized in that the profiled portion (5) is rounded at the edge.

7. Glass or glass ceramic plate according to any one of the foregoing claims, characterized in that the profiled portion (5) runs around the plate (1).

8. Glass or glass ceramic plate according to any one of the foregoing claims, characterized in that the profiled portion (5) is rounded at the comers (15) of the plate (1).

9. Glass or glass ceramic plate according to any one of the foregoing claims, characterized in that the profiled portion (5) is elevated by a height (H1) over the flat upper side (2) of the plate (1) such that a catchment for liquid is formed.

10. Glass or glass ceramic plate according to any one of the foregoing claims, characterized in that the profiled portion (5) merges at a convex round (8) and a concave round (6′) into the bottom side (3) of the plate (1).

11. Glass or glass ceramic plate according to claim 10, characterized in that a flat zone (10, 10′) is provided between the convex round (8, 9) and the concave round (6, 6′).

12. Glass or glass ceramic plate according to either of the preceding claims 10 or 11, characterized in that the end face (7) of the profiled portion is rounded to merge with the rounds (8, 9).

13. Method for the manufacture of a glass or glass ceramic plate for a kitchen appliance, which has a safe edge, characterized in that the plate is first made by rolling and then, in the green state, is upset or shaped such that there a profiled portion thickened in relation to the thickness of the plate is formed, and that then the plate is heat treated and/or ceramicized to reach its finished state.

14. Method according to claim 13, characterized in that the plate is heated in the green state to reduce thermal stresses and additionally heated in its marginal area and upset or shaped by means of a forming tool to form the profiled portion.
